(19) United States
(12) Patent Application Publication
(10) Pub. No.: US 2024/0229668 A1
(43) Pub. Date: Jul. 11, 2024

(54) BRUSH SEAL FOR A TURBOMACHINE

(71) Applicant: MTU Aero Engines AG, Muenchen (DE)

(72) Inventors: Johann GOETTLER, Egenhofen (DE); Stefan BEICHL, Herrsching (DE); Romain MANDARD, Petershausen (DE)

(21) Appl. No.: 18/420,982

(22) Filed: Jan. 24, 2024

(30) Foreign Application Priority Data
Jan. 25, 2023 (DE) 102023101856.6

(51) Int. Cl. F01D 11/00

(52) U.S. Cl. CPC F01D 11/003; F05D 2240/56; F05D 2300/177

(57) ABSTRACT

A brush seal for a turbomachine which has improved sealing performance above an operating temperature of 700° C. The brush seal includes a bristle package made of a Ni-based alloy. A turbomachine and to a method for manufacturing a brush seal is provided.

This claims the benefit of German Patent Application DE 102023101856.6, filed on Jan. 25, 2023 which is hereby incorporated by reference herein.

### DESCRIPTION

The invention relates to a brush seal for a turbomachine, a corresponding turbomachine, and to a method for manufacturing the brush seal.

### BACKGROUND

Various brush seals for thermal turbomachines are known from the prior art. There are a large number of applications where two relatively movable parts must be non-hermetically sealed against one another. An example of such an application is sealing an annular gap through which gas flows between a stator and a rotor of a turbomachine, in particular a gas turbine for an aircraft. Often, brush seals are used for non-hermetic sealing of annular spaces between relatively rotating assemblies, since brush seals are lighter in weight and more compact than labyrinth seals for the same sealing effect.

Brush seals are known, for example, from EP 1 146 266 A2 or EP 2 857 721 A1. Brush seals may essentially include a cover ring, a support ring, and a sealing element. The sealing element may include the bristle package, which may be formed by a multiplicity of thin wires or fibers, which may be fixed with a core wire in a clamping tube. Gases entering the turbomachine are forced to flow through the bristle package, which is also referred to as bristle pack. In this process, the gas presses the wires against the support ring, thus compacting the bristle package. This reduces the permeability of the brush seal to a minimum. Due to their elasticity, the wires or fibers of the bristle package can compensate for axial and radial rotor movements with almost no wear, whereupon they return to their original position.

### SUMMARY OF THE INVENTION

The material currently used for the bristle package in brush seals is generally a cobalt-based material, known in particular by the trade name Haynes 25. This material can be temperature-resistant up to 980° C. However, the cobalt-based materials heretofore used for bristle packages are limited to maximum temperatures between 600° C. and 700° C., especially because of the creep and relaxation properties. In particular, the function of the brush seal may be dependent on the spring characteristic of the bristle package. For example, an excessively fast relaxation of the brush seal caused by the thermomechanical load on the bristle package may lead to a degradation of the spring characteristic, an increase in the size of the sealing gap, and thus to a deterioration of the sealing performance. Currently, sealing locations with operating temperatures above 600° C. or 700° C. cannot be covered with brush seals. However, at many sealing points in a modern turbomachine, the maximum temperatures are above this temperature limit.

In addition to the high temperature resistance of the bristle package, further properties of the bristle package, in particular of the material of the bristle package, are required for use in modern turbomachines, in particular the previously mentioned creep and relaxation properties at high operating temperatures as well as corrosion properties and the heat input properties during rubbing of the bristle package against the rotor.

It is an object of the invention to provide a brush seal for a turbomachine which has improved sealing performance above an operating temperature of 700° C.

A first aspect of the invention provides a brush seal for a turbomachine, which brush seal has a bristle package made of a Ni-based alloy.

In other words, the brush package is manufactured from a Ni-based alloy or a Ni-based material. In particular, it may be provided that a multiplicity of wires or bristles of the bristle package, which are combined to form the bristle package, are made of the Ni-based alloy. The multiplicity of wires may in particular be fixed around a core wire in a clamping tube. Preferably, the brush seal further includes a cover ring and a support ring.

An advantage of using the Ni-based alloy for the bristle package in a brush seal, especially for a turbomachine, is that this metallic high-temperature material extends an operating temperature range of the brush seals significantly compared to a cobalt-based material, in particular far beyond an operating temperature of 700° C., in particular up to a maximum temperature of 750° C., preferably up to a maximum temperature of 800° C. Even in this extended temperature range, the bristle package has excellent creep and relaxation properties, so that a spring characteristic of the bristle package remains stable. Furthermore, the Ni-based alloy for use as a bristle package provides high resistance to corrosion and induces relatively low heat input into the brush seal as a result of the friction on the rotor.

The invention also includes embodiments of Ni-based alloys that provide additional advantages. The percentages of the individual elements in the embodiments of the Ni-based alloys refer to percentages by mass (mass %).

One embodiment provides that the Ni-based alloy of the bristle package contains the following chemical elements: 7% to 24% Co, 15% to 24% Cr, up to 11% Mo, up to 5% Al, and up to 5% Ti, with the remainder of the alloy being substantially Ni, apart from inevitable impurities. A content of inevitable impurities may preferably be no more than 0.5%. In particular, this Ni-based alloys is hardenable, so that the desired material properties may be provided after hardening. In Table 1, this Ni-based alloy is designated as “Material Type A.”

One embodiment provides that the Ni-based alloy of the bristle package contains the following chemical elements: 2% to 12% Fe, 10% to 20% Cr, up to 5% Ti, and up to 5% Al, with the remainder of the alloy being substantially Ni, apart from inevitable impurities. A content of inevitable impurities may preferably be no more than 0.5%. In particular, this Ni-based alloy is hardenable, so that the desired material properties may be provided after hardening. In Table 1, this Ni-based alloy is designated as “Material Type B.”

One embodiment provides that the Ni-based alloy of the bristle package contains the following chemical elements: 7% to 16% Co, 17% to 26% Cr, 5% to 13% Mo, up to 5% Ti, and up to 5% Al, with the remainder of the alloy being substantially Ni, apart from inevitable impurities. A content of inevitable impurities may preferably be no more than 0.5%. In particular, it may be provided that this Ni-based alloy does not need to be hardened to provide the desired material properties. Preferably, the Ni-based alloy can be used in the solution-annealed condition. In Table 2, this Ni-based alloy is designated as “Material Type C.”

One embodiment provides that the Ni-based alloy of the bristle package contains the following chemical elements: 5% to 14% Fe, 21% to 29% Cr, up to 5% Al, and up to 5% Ti, with the remainder of the alloy being substantially Ni, apart from inevitable impurities. A content of inevitable impurities may preferably be no more than 0.5%. In particular, it may be provided that this Ni-based alloy does not need to be hardened to provide the desired material properties. Preferably, the Ni-based alloy can be used in the solution-annealed condition. In Table 2, this Ni-based alloy is designated as “Material Type D.”

An advantage of the respective embodiments is that this metallic high-temperature material extends an operating temperature range of the brush seals significantly compared to a cobalt-based material, in particular far beyond an operating temperature of 700° C., in particular up to a maximum temperature of 750° C., preferably up to a maximum temperature of 800° C. Even in this extended temperature range, the bristle package has excellent creep and relaxation properties, so that a spring characteristic of the bristle package remains stable. Furthermore, the Ni-based alloy for use as a bristle package provides high resistance to corrosion and induces relatively low heat input into the brush seal as a result of the friction on the rotor.

Another aspect of the invention provides a turbomachine having at least one brush seal according to the invention. By using the inventive brush seal in a turbomachine, an efficiency of the turbomachine can be increased due to the improved sealing performance. Moreover, the turbomachine can be operated at higher working temperatures in the areas where the brush seals are used, so that, for example, an internal efficiency can be increased. In particular, this advantageously allows for fuel savings.

One embodiment provides that the turbomachine is configured as a gas turbine, in particular as an aircraft gas turbine.

One embodiment provides that the turbomachine is configured as a steam turbine.

One embodiment provides that the turbomachine is configured as an industrial compressor.

Another aspect of the invention provides a method for manufacturing a brush seal according to the invention. In particular, a wire made of the Ni-based alloy may be provided, a multiplicity of wires being assembled to form the bristle package of the brush seal.

Non-hardenable Ni-based alloys may have the advantage of providing the desired material properties already after assembly to form the brush seal, without having to be hardened by a heat treatment.

A further aspect of the invention provides another method for manufacturing a brush seal according to the invention, wherein the bristle package of the brush seal is subjected to a heat treatment to harden the Ni-based alloy. In particular, the Ni-based alloy used for this method is hardenable.

### BRIEF DESCRIPTION OF THE DRAWING

FIG. 1 shows solely schematically a brush seal of the present invention with the Ni-based alloy.

### DETAILED DESCRIPTION

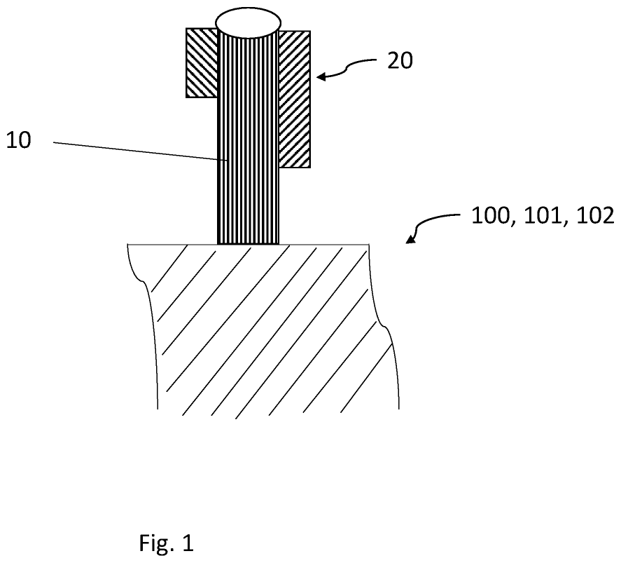

FIG. 1 shows schematically a brush seal 10 of an aircraft gas turbine 100, industrial gas turbine 101 or steam turbine 102, all shown schematically.

Preferably, first, a multiplicity of wires is assembled to form the bristle package 10 of the brush seal 20. Then, the assembled brush seal is hardened by heat treatment. “Hardening” (also referred to as “age hardening” or “precipitation hardening”) is understood to be a heat treatment that increases the hardness and strength of the material, in particular of the Ni-based alloy. After hardening, the bristle package advantageously obtains the desired material properties, such as creep and relaxation properties.

Table 1 summarizes the hardenable Ni-based alloys. Table 2 summarizes the Ni-based alloys that can be used in the solution-annealed condition and do not need to be hardened. The indicated Ni content in mass percent in each case represents only a possible range for the remainder of the alloy.

TABLE 1
Compositions of the hardenable Ni-based alloys

| | |
|---|---|
| Material Type A | Material Type B |

Composition in mass %

| | | |
|---|---|---|
| Ni | 31-78 (remainder) | 58-88 (remainder) |
| Co | 7-24 | — |
| Fe | — | 2-12 |
| Cr | 15-24 | 10-20 |
| Mo | 0-11 | — |
| Al | 0-5 | 0-5 |
| Ti | 0-5 | 0-5 |

TABLE 2
Compositions of nickel-based materials that can
be used in the solution-annealed condition

| | |
|---|---|
| Material Type C | Material Type D |

Composition in mass %

| | | |
|---|---|---|
| Ni | 35-71 (remainder) | 47-74 (remainder) |
| Co | 7-16 | — |
| Fe | — | 5-14 |
| Cr | 17-26 | 21-29 |
| Mo | 5-13 | — |
| Al | 0-5 | 0-5 |
| Ti | 0-5 | 0-5 |

1-10. (canceled)

11. A brush seal for a turbomachine, comprising:
a bristle package made of a Ni-based alloy.

12. The brush seal as recited in claim 11 wherein the Ni-based alloy of the bristle package contains the following chemical elements: 7% to 24% Co, 15% to 24% Cr, up to 11% Mo, up to 5% Al, and up to 5% Ti, all percentages given above being in mass %, with a remainder of the alloy being Ni and inevitable impurities.

13. The brush seal as recited in claim 11 wherein the Ni-based alloy of the bristle package contains the following chemical elements: 2% to 12% Fe, 10% to 20% Cr, up to 5% Al, and up to 5% Ti, all percentages given above being in mass %, with a remainder of the alloy being Ni and inevitable impurities.

14. The brush seal as recited in claim 11 wherein the Ni-based alloy of the bristle package contains the following chemical elements: 7% to 16% Co, 17% to 26% Cr, 5% to 13% Mo, up to 5% Ti, and up to 5% Al, all percentages given above being in mass %, with a remainder of the alloy being Ni and inevitable impurities.

15. The brush seal as recited in claim 11 wherein the Ni-based alloy of the bristle package contains the following chemical elements: 5% to 14% Fe, 21% to 29% Cr, up to 5% Al, and up to 5% Ti, all percentages given above being in mass %, with a remainder of the alloy being Ni and inevitable impurities.

16. A turbomachine comprising the brush seal as recited in claim 11.

17. The turbomachine as recited in claim 16 wherein the turbomachine is configured as a gas turbine.

18. The turbomachine as recited in claim 17 wherein the gas turbine is an aircraft gas turbine.

19. The turbomachine as recited in claim 17 wherein the gas turbine is an industrial gas turbine.

20. The turbomachine as recited in claim 16 wherein turbomachine is configured as a steam turbine.

21. A method for manufacturing a brush seal comprising providing a bristle package made of a Ni-based alloy.

22. The method as recited in claim 21 wherein the bristle package is subjected to a heat treatment to harden the Ni-based alloy.
